(19) United States
(12) Patent Application Publication
(10) Pub. No.: US 2014/0289597 A1
(43) Pub. Date: Sep. 25, 2014

(54) METHOD AND DEVICE FOR DISPLAYING PREVIEW SCREEN OF HYPERLINK

(71) Applicant: Samsung Electronics Co., Ltd., Suwon-si (KR)

(72) Inventor: Sangheon KIM, Gumi-si (KR)

(73) Assignee: Samsung Electronics Co., Ltd., Suwon-si (KR)

(21) Appl. No.: 14/202,678

(22) Filed: Mar. 10, 2014

(30) Foreign Application Priority Data
Mar. 19, 2013 (KR) 10-2013-0029220

(51) Int. Cl. G06F 17/22

(52) U.S. Cl. CPC G06F 17/2235; G06F 17/2247
USPC 715/205

(57) ABSTRACT

A method and a device for displaying a preview screen of a hyperlink which can display a preview screen of a site connected to at least one hyperlink on a popup or a sub-frame according to a user input are provided. The method includes displaying a web page on a browser, generating at least one preview screen for at least one hyperlink corresponding to a preview screen display request when the preview screen display request for the at least one hyperlink configuring the web page is detected, and displaying the at least one preview screen in an area of the browser.

### CROSS-REFERENCE TO RELATED APPLICATION(S)

This application claims the benefit under 35 U.S.C. §119(a) of a Korean patent application filed on Mar. 19, 2013 in the Korean Intellectual Property Office and assigned Serial number 10-2013-0029220, the entire disclosure of which is hereby incorporated by reference.

### TECHNICAL FIELD

The present disclosure relates to a method and a device for displaying a preview screen of a hyperlink. More particularly, the present disclosure relates to a method and a device for displaying a preview screen of a hyperlink which can display a preview screen of a web page connected to at least one hyperlink on a popup or a sub-frame according to a user input.

### BACKGROUND

In general, for displaying of a web page connected by a hyperlink on a page displayed in the browser, a browser screen is updated or a new browser tab is generated. Accordingly, a user should update the browser screen or perform a screen converting operation by generation of a new window in order to view the web page connected to a plurality of desired hyperlinks. Further, the user should load a previous web page again or move to another browser tab in order to return to the originally displayed web page from the web page connected to the hyperlink.

More particularly, in utilizing limited resources, such as mobile environments, updating the browser screen or generating the plurality of browser tabs cause several problems in terms of availability.

Thus, a need exists for a method and a device for providing more efficient and convenient preview screens.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for displaying a preview screen of a hyperlink which can display a preview screen of a web page corresponding to a hyperlink on a popup or a plurality of sub-frames according to a user input.

Another aspect of the present disclosure is to provide a method and a device for displaying a preview screen of a hyperlink which can configure a preview screen with a focus area or a text of a web page corresponding to a hyperlink.

In accordance with an aspect of the present disclosure, a method for displaying a preview screen of a hyperlink in an electronic device is provided. The method includes displaying a web page on a browser, generating at least one preview screen for each of at least one hyperlink corresponding to a preview screen display request when the preview screen display request for the at least one hyperlink configuring the web page is detected, and displaying the at least one preview screen in an area of the browser.

In accordance with another aspect of the present disclosure, a device for displaying a preview screen of a hyperlink is provided. The device includes a display unit configured to display a web page on a browser, an input unit configured to detect a preview screen display request for at least one hyperlink configuring the web page, and a controller configured to generate at least one preview screen for each of at least one hyperlink corresponding to the request and to control the display unit to display the at least one preview screen in an area of the browser, when the request is detected through the input unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a preview screen display device according to an embodiment of the present disclosure;

FIG. 2 is a flowchart illustrating a preview screen display method according to an embodiment of the present disclosure;

FIG. 3 is a diagram illustrating a web page including at least one hyperlink according to an embodiment of the present disclosure;

FIG. 4 is a flowchart illustrating a preview screen creating method according to an embodiment of the present disclosure;

FIG. 5 is a diagram illustrating a procedure of extracting a preview object according to an embodiment of the present disclosure;

FIG. 6 is a diagram illustrating a HyperText Markup Language (HTML) code of a web page according to an embodiment of the present disclosure;

FIG. 7 illustrates a preview screen in a case of extracting a partial area of a web page as a preview object according to an embodiment of the present disclosure;

FIG. 8 illustrates a preview screen in a case of extracting texts as a preview object according to an embodiment of the present disclosure;

FIG. 9 is a diagram illustrating a display of a preview screen according to a popup effect according to an embodiment of the present disclosure;

FIG. 10 is a flowchart illustrating a preview screen display method according to an embodiment of the present disclosure;

FIG. 11 is a diagram illustrating a procedure of configuring a sub-frame for a preview screen in a portrait mode according to an embodiment of the present disclosure;

FIG. 12 is a diagram illustrating a procedure of configuring a sub-frame for a preview screen in a landscape mode according to an embodiment of the present disclosure; and

FIG. 13 is a diagram illustrating a procedure of changing a displayed web page with a preview screen according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Embodiments of the present disclosure may be applied to an electronic device providing a browser so as to control displaying of a preview screen.

Further, embodiments of the present disclosure may be applied to all devices providing a browser as well as general electronic terminals, including a smart phone, a portable terminal, a mobile terminal, a Personal Digital Assistant (PDA), a Portable Multimedia Player (PMP) terminal, a notepad, a WiBro terminal, a tablet Personal Computer (PC), a computer, a multimedia device, and the like, which provide a browser.

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning.

In addition, a singular expression used in the specification includes a plural expression as long as they are clearly distinguished in the context. Throughout the specification, the terms such as “comprise” or “include” should not be construed as necessarily including all of the various component or steps described in the specification.

Hereinafter, various embodiments of the present disclosure will be described below with reference to the accompanying drawings.

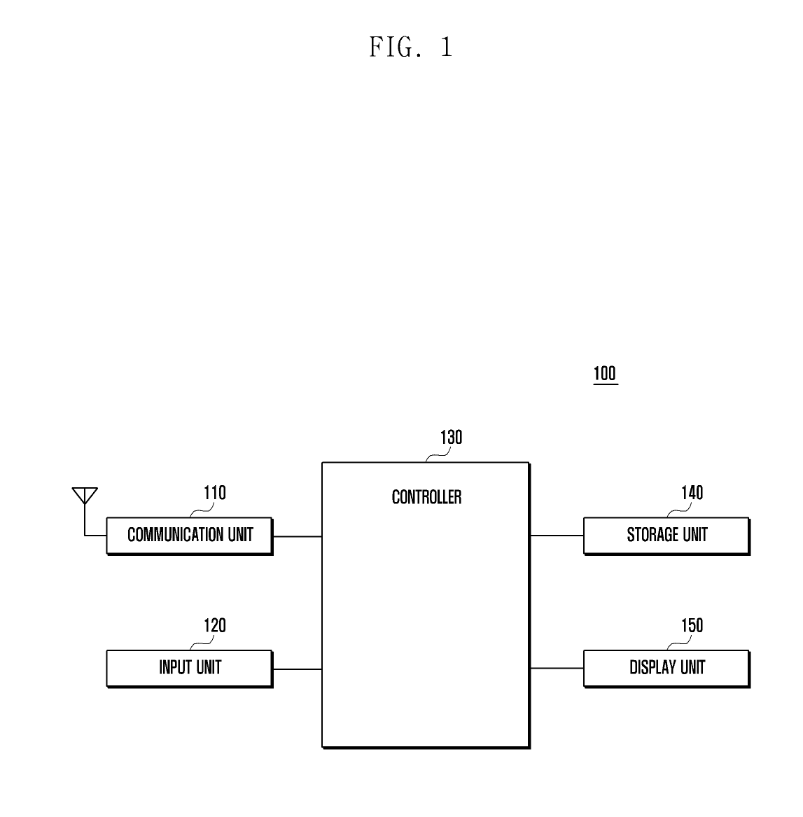

FIG. 1 is a block diagram illustrating a configuration of a preview screen display device according to an embodiment of the present disclosure.

Referring to FIG. 1, a preview screen display device 100 may include a communication unit 110, an input unit 120, a controller 130, a storage unit 140, and a display unit 150.

The communication unit 110 may include one or more modules enabling wireless communication between the preview screen display device 100 and a wireless communication system or between the preview screen display device 100 and a mobile communication system in which the preview screen display device 100 is located. More specifically, the communication unit 110 transmits/receives a wireless signal to/from at least one of a base station, another preview screen display device, and a server on a mobile communication network. The wireless signal may include a voice call signal, a video call signal, or various types of data according to text/multimedia message transmission/reception. Further, the communication unit 110 may exchange data with external devices by using communication technologies, such as Wireless Local Area Network (WLAN), Wi-Fi, Wireless broadband (Wibro), World Interoperability for Microwave Access (Wimax), High Speed Downlink Packet Access (HSDPA), and the like.

According to an embodiment of the present disclosure, the communication unit 110 may transmit a request message for requesting data on a web page to a server and may receive a response message including the data on the web page from the server under control of the controller 130.

The input unit 120 detects a user input and transfers an input signal corresponding to the user input to the controller 130. The input unit 120 may include a keypad, a dome switch, a touch pad (resistive type/capacitive type), a jog wheel, a jog switch, a finger mouse, a wheel, and the like.

The input unit 120 may be configured in a form including a touch sensor, a proximity sensor, an electromagnetic sensor, a pressure sensor, and the like. The input unit 120 may detect a user touch input or proximity input through a sensor. The input unit 120 may be configured as an input pad in which a sensor is attached in a film form or coupled in a panel form to a pad. Alternatively, the input unit 120 may be configured by an input pad in the type of an Electro Magnetic Resonance (EMR) or an Electro Magnetic Interference (EMI) using an electromagnetic sensor.

The input unit 120 may form a layer structure together with the display unit 150, which will be described below, to operate as an input screen. For example, the input unit 120 may include an input pad having a touch sensor and may be configured with a Touch Screen Panel (TSP) coupled with the display unit 150. The input unit 120 forming the layer structure together with the display unit 150 may be referred to as a touch screen.

According to an embodiment of the present disclosure, the input unit 120 may detect an input corresponding to a request for displaying of a preview screen. Alternatively, the input unit 120 may detect an input for the displayed preview screen.

The input unit 120 may generate a control signal including information on a location, an input type, and the like, of the detected input and may transfer the generated control signal to the controller 130.

The controller 130 may control respective elements for an overall operation of the preview screen display device 100. For example, the controller 130 may control the display unit 150 to generate a preview screen of a web page connected to a hyperlink displayed on a browser according to a user input and display the generated preview screen.

According to an embodiment of the present disclosure, when a request corresponding to displaying of a preview screen is detected through the input unit 120, the controller 130 controls the display unit 150 to generate at least one preview screen for at least one hyperlink corresponding to the request and display the generated preview screen in an area of the browser.

According to an embodiment of the present disclosure, the controller 130 may control the communication unit 110 to transmit, to the server, a request message for requesting data on at least one web page connected by the at least one hyperlink corresponding to the request and to receive a response message including the data from the server.

According to an embodiment of the present disclosure, the controller 130 may extract texts or may extract data corresponding to a specific area of the web page to generate a preview screen configured with the texts or the specific area.

According to an embodiment of the present disclosure, the controller 130 may determine generation of the preview screen based on legibility of the web page. Further, the controller 130 may display the preview screen by configuring a sub-frame for the preview screen based on a screen display mode of the display unit 150.

A description of more specific operations of the controller 130 will be described below with reference to the accompanying drawings.

The storage unit 140 may store programs or commands for the preview screen display device 100. The controller 130 may execute the programs or commands stored in the storage unit 140.

The storage unit 140 may include at least one type of storage medium of a flash memory type memory, a hard disk type memory, a multimedia card micro type memory, a card type memory (for example, a Secure Digital (SD) memory card, an XD memory card, and the like), a Random Access Memory (RAM), a Static RAM (SRAM), a Read-Only Memory (ROM), an Electrically Erasable Programmable ROM (EEPROM), a PROM, a magnetic memory, a magnetic disk, an optical disk, and the like.

According to an embodiment of the present disclosure, the storage unit 140 temporarily or permanently stores the data of the web page corresponding to the hyperlink received from the server. Further, the storage unit 140 may also store the information on the preview screen generated in correspondence to the hyperlink.

The display unit 150 displays (outputs) information processed by the preview screen display device 100. For example, the display unit 150 may display information corresponding to an application, a program, or a service, which is being currently driven, together with a User Interface (UI) or a Graphical User Interface (GUI).

The display unit 150 may form a mutual layer structure together with the input unit 120 to operate as a touch screen. At this time, the display unit 150 operating as the touch screen may also perform a function of an input device.

According to an embodiment of the present disclosure, the display unit 150 displays the preview screen of the hyperlink under the control of the controller 130. The display unit 150 may display at least one preview screen in a popup window or a sub-frame.

The elements illustrated in FIG. 1 are not indispensable, and the preview screen display device 100 may be implemented to have more elements or fewer elements.

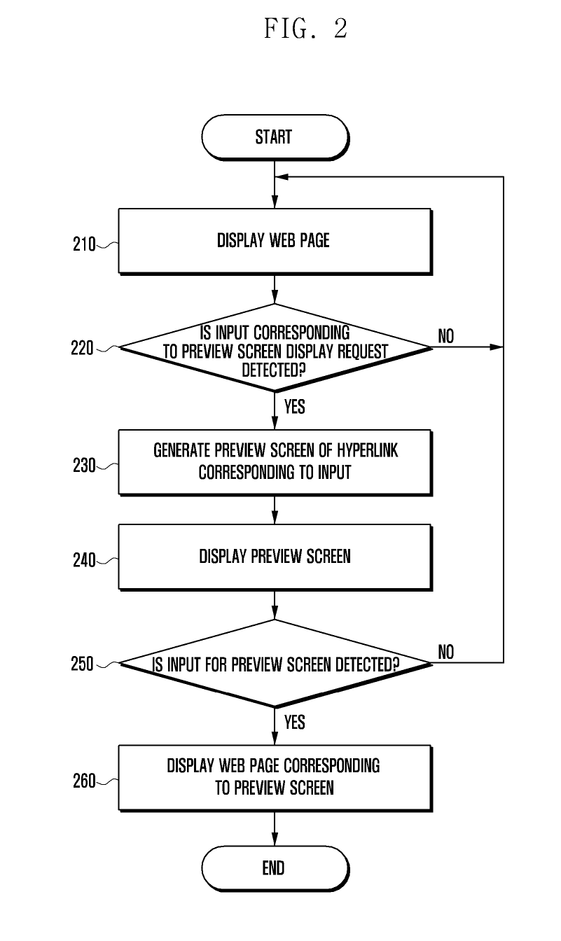

FIG. 2 is a flowchart illustrating a preview screen display method according to an embodiment of the present disclosure. Although a case in which the preview screen display device 100 displays a preview screen of a web page will be described as an example in a control method of the preview screen display device, the preview screen display device 100 may be applied to various embodiments of displaying a preview screen for content, such as a photo, a video image, a sound source, a flash file, and the like, without being limited thereto.

Referring to FIG. 2, first, a controller 130 may display a web page in operation 210.

The controller 130 may drive a browser for displaying the web page according to a user request through an input unit 120 or a request of an application, a program, a service, and the like. The browser corresponds to an application enabling search, identification, management, storage, and print of all information provided by the web and may include a Web browser or a Wireless Application Processor (WAP) browser.

The browser may be a general browser, such as Internet Explorer, Opera, Firefox, Chrome, Lunascape, Mozila, Safari, and the like for an electronic device having a large resource capacity, such as a computer, or a micro-browser, such as Webkit, Gecko, and the like, for supporting a web function in a mobile environment. According to an embodiment of the present disclosure, the browser may support the Web or the WAP, or may support both the Web and the WAP.

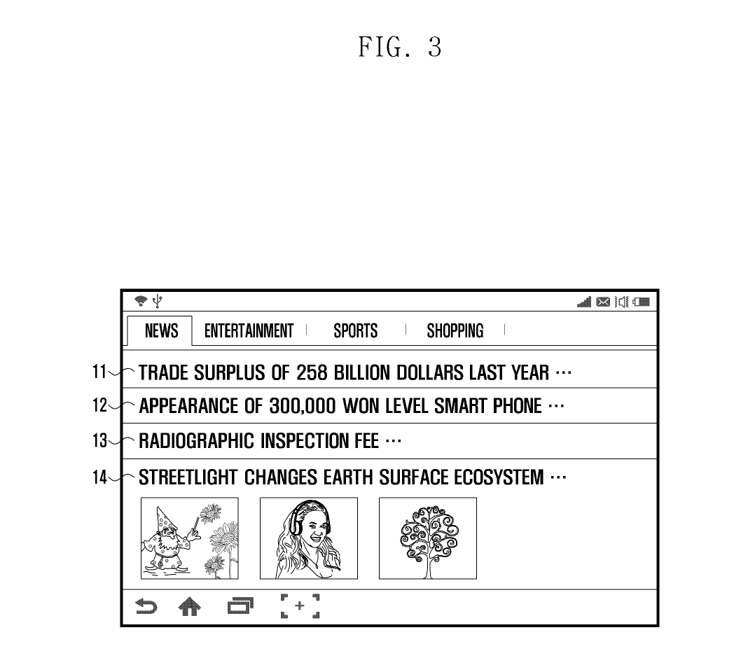

FIG. 3 is a diagram illustrating a web page including at least one hyperlink according to an embodiment of the present disclosure.

Referring to FIG. 3, the controller 130 controls a display unit 150 to display a web page requested by a user, an application, a program, a service, and the like, on the driven browser. Alternatively, the controller 130 may control the display unit 150 to display a web page set as an initial screen according to an option of the browser. As illustrated in FIG. 3, the controller 130 may control the display unit 150 to display at least one menu and icon configuring the browser together with the web page. At this time, the controller 130 may control the display unit 150 to display a portion or the whole of the web page according to a size and a resolution of the display unit 150.

The web page is received from a web server through a communication unit 110 and is created using a Hypertext Markup Language (HTML), an Extensible Hypertext Language (XHTML), Cascading Style Sheets, JavaScript, Flash, and the like. The web page may be created based on a Web browser or WAP browser environment, and may be accordingly classified into a Web page and a WAP page.

The web page may be configured with at least one text, a still image, a moving image, and the like. More particularly, the web page may include at least one hyperlink in the embodiment of the present disclosure. The hyperlink is an element of the web page that connects two or more web pages, and the web page connected by the hyperlink can be viewed on the browser through a selection of the hyperlink. The hyperlink is displayed as a text, a still image, a moving image, and the like, within the web page and has a Uniform Resource Locator (URL) of the connected web page as attribute information. When selecting the hyperlink displayed as the text, the still image, the moving image, and the like, a user may identify the web page connected by the hyperlink, by using the URL input to the attribute information.

Referring to FIG. 3, the controller 130 may control the display unit 150 to display a web page including at least one hyperlink 11, 12, 13, and 14 on the browser. In FIG. 3, the at least one hyperlink 11, 12, 13, and 14 corresponding to respective news articles is displayed as a text.

The controller 130 may temporarily or permanently store the URL of the displayed web image and the content configuring the web page (e.g., the text, the still image, the moving image, and the like) in the storage unit 140. The controller 130 may also separately extract the information of the hyperlink included in the web page and may store the extracted information in the storage unit 140.

Thereafter, the controller 130 determines in operation 220 whether an input corresponding to a preview screen display request is detected.

The input corresponding to the preview screen display request may be generated by a specific input unit or input type. For example, the input corresponding to the preview screen display request may be a hovering input by which a stylus pen is located close to the hyperlink for a certain period of time. Further, for example, the input corresponding to the preview screen display request may be a long press touch input for the hyperlink by a user's body or a stylus pen. The input corresponding to the preview screen display request may be generated by the user's body (e.g., a finger, and the like) or the stylus pen. Further, the input corresponding to the preview screen display request may be generated by any one of a touch input, a proximity input, or a hovering input for the hyperlink of the web page. The input corresponding to the preview screen display request may be configured by a click, a double click, a long press, a drag-and-drop input, and the like, on the hyperlink.

For example, the input corresponding to the preview screen display request may be a hovering input by which the stylus pen is located close to the hyperlink for a certain period of time. Further, for example, the input corresponding to the preview screen display request may be a long press touch input for the hyperlink by a user's body or a stylus pen.

In one embodiment of the present disclosure, the aforementioned input may correspond to a menu display request for the hyperlink. The menu for the hyperlink may include a preview screen display menu and may further include menus, such as an Open menu, an Open New Window menu, a Copy URL menu, and the like. In this case, the input corresponding to the preview screen display request may be an input for selecting the preview screen display menu.

When a sub-frame for displaying of the preview screen has already been displayed, the aforementioned input may correspond to a request for displaying the preview screen on the specific sub-frame. For example, when a touch input is generated for a specific hyperlink and thereafter, a drag-and-drop input is generated toward a specific sub-frame, the input may correspond to a request for displaying a preview screen of the specific hyperlink on the sub-frame where the specific hyperlink is drag-and-dropped.

The input corresponding to the preview screen display request may be generated for two or more hyperlinks. For example, in a case of generating a multi-touch input for two or more hyperlinks, continuously selecting hyperlinks while a button included in a stylus pen is being clicked, or entering a mode for selecting two or more hyperlinks through a menu, a shortcut icon, or the like, the input corresponding to the preview screen display request may be generated for the two or more hyperlinks.

The input corresponding to the preview screen display request may be stored in the storage unit 140 while being set together with information on an input unit, an input type, and the like.

Although several examples of the input corresponding to the preview screen display request have been described above, various types of input through various input units may be set to correspond to the preview screen display request, without being limited thereto.

The controller 130 determines whether a user input is detected on the browser through the input unit 120 or the display unit 150 implemented with a touch screen. When the user input for the browser is detected while the browser is being displayed, the input unit 120 or the display unit 150 implemented with the touch screen may generate a control signal corresponding to the user input to transfer the generated control signal to the controller 130. The control signal may include a location where the user input has been detected, information on the input unit having generated the user input (e.g., a finger, a stylus pen, and the like), and information on the input type (e.g., information on a touch input, a proximity input, a hovering input, a manipulation state of a button included in a stylus pen, and the like). The controller 130 may obtain information on the detected user input based on the control signal transferred from the input unit 120 or the display unit 150.

The controller 130 determines based on the obtained information from the user input whether the input for the hyperlink has been detected. The controller 130 determines whether the location where the user input has been generated corresponds to a location where the hyperlink has been displayed. When the user input is generated at the location where the hyperlink has been displayed, the controller 130 may determine that the input for the hyperlink has been detected.

The controller 130 determines based on the control signal received from the input unit 120 or the display unit 150 whether the detected input corresponds to the preview screen display request. For example, when the detected input corresponds to a hovering input that a stylus pen is located close to the hyperlink for a certain period of time, the controller 130 may determine that the input corresponds to the preview screen display request. Further, for example, when the detected input corresponds to a long press touch input by a user's body or a stylus pen for the hyperlink, the controller 130 may determine that the input corresponds to the preview screen display request.

As the input corresponding to the preview screen display request is generated, the controller 130 may collect information on the hyperlink for which the input has been generated. For example, the controller 130 may collect a URL of the web page connected by the hyperlink. Further, the controller 130 may apply a highlight effect to the hyperlink detected in response to the preview screen display request as illustrated in FIG. 3.

When the input corresponding to the preview screen display request has not been detected, the controller 130 may return to an opeartion of displaying the web page and may control the display unit 150 to display the web page. Moreover, the controller 130 may control the display unit 150 to perform renewal of the web page according to a certain period of time and display the refreshed web page.

On the other hand, when the input corresponding to the preview screen display request has been detected, the controller 130 generates a preview screen of the hyperlink corresponding to the input in operation 230.

The controller 130 may generate the preview screen of the web page connected by the hyperlink corresponding to the input.

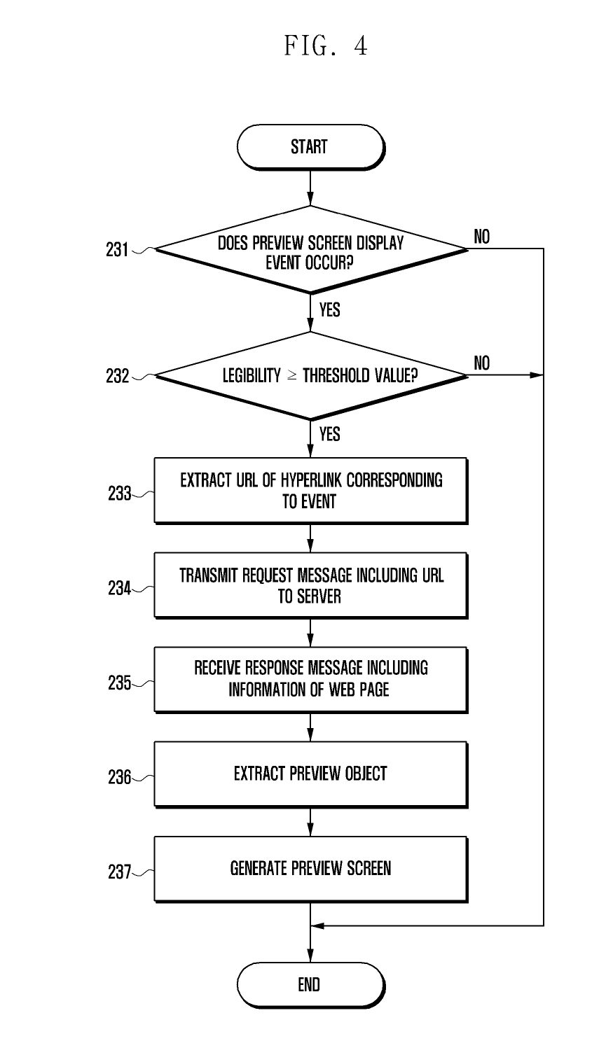

FIG. 4 is a flowchart illustrating a preview screen creating method according to an embodiment of the present disclosure.

Referring to FIG. 4, the controller 130 determines in operation 231 whether a preview screen display event has occurred.

The preview screen display event may occur by the detection of the input corresponding to the preview screen display request. Here, the input corresponding to the preview screen display request may be detected through the aforementioned processes. Alternatively, the preview screen display event may occur through a request generated by an application, a program, a service, and the like.

In the embodiment of the present disclosure, the preview screen display event may occur by detection of an input corresponding to a request for zoom-in of the displayed web page. In a general mobile terminal, a size of the display unit 150 is so small that legibility of the preview screen may be deteriorated although displayed together with the web page. Accordingly, when displaying the web page at a magnification level of an initial value, the controller 130 may not perform an operation of displaying the preview screen. On the other hand, when the displayed web page is zoomed in by the request, legibility of the web page is relatively enhanced so that the controller 130 may perform the operation of displaying the preview screen. Accordingly, the preview screen display event may occur according to the request for zoom-in of the web page being displayed. The input corresponding to the request for zoom-in of the web page may be configured with, for example, a double click, a pinch out, and the like.

If the preview screen display event does not occur, the controller 130 may terminate a process of generating the preview screen.

When the preview screen display event has occurred, the controller 130 may determine in operation 232 whether legibility of the web page is greater than or equal to a threshold value.

As described above, when the size of the display unit 150 or the text configuring the web page is so small that the displayed text is illegible, displaying the preview screen on the browser inconveniences users and may be inefficient. Accordingly, in an embodiment of the present disclosure, the preview screen may be displayed when the legibility of the displayed web page is greater than or equal to the threshold value.

The controller 130 may determine the legibility of the displayed web page. The legibility may be determined based on a text size and a magnification/reduction rate of the currently displayed web page, a size and a resolution of the display unit 150, a size of a blank area configuring the web page, and the like.

The threshold value of the legibility for displaying the preview screen may be set by a user or a manufacturer. The threshold value may be expressed as a value denoting a text size and a magnification/reduction rate of the displayed web page, a size and a resolution of the display unit 150, and a size of a blank area configuring the web page. The threshold value may be determined as a size to an extent that users do not feel inconvenienced to view the web page and the preview screen, when the preview screen is experimentally or empirically displayed according to the size and the resolution of the display unit 150.

The controller 130 compares the determined legibility with the threshold value to determine whether the legibility is greater than or equal to the threshold value.

When the legibility is less than the threshold value, the controller 130 may terminate the process of generating the preview screen. The controller 130 may output a notice that the legibility is too low to display the preview screen, through a popup window, a message, an emoticon, a voice notification, an alert sound, a vibration, and the like.

When the legibility is greater than or equal to the threshold value, the controller 130 extracts a URL of the hyperlink corresponding to the event in operation 233.

A URL is a logic address for displaying a network path of a web page in the web and may be formed according to protocols including http, ftp, mailto, file, gopher, telnet, news, and the like.

The controller 130 extracts the URL of the hyperlink corresponding to the preview screen display event. The controller 130 may extract the URL among attribute information of the hyperlink from an HTML (or XHTML) code and a CSS code of the web page. For example, when the web page is created through the HTML code, the URL may have been included in a hypertext reference (href) attribute among the attribute information of the hyperlink. The controller 130 may extract the URL of the hyperlink input to the href attribute and may temporarily or permanently store the extracted URL in the storage unit 140. When the preview screen display event has occurred for a plurality of hyperlinks, the controller 130 may extract URLs for the plurality of hyperlinks, respectively.

In an embodiment of the present disclosure, the controller 130 may select a hyperlink from which the URL will be extracted, in response to the preview screen display event. When the preview screen display event occurs by a user input, the controller 130 may select a hyperlink corresponding to the input as the hyperlink from which the URL will be extracted. Alternatively, the controller 130 may select at least one hyperlink found within a range on the browser as the hyperlink from which the URL will be extracted.

For example, in a case of displaying a portion of the web page on the browser, the controller 130 may select a hyperlink included in the displayed portion as the hyperlink from which the URL will be extracted. Alternatively, when the preview screen display event occurs by a user input, the controller 130 may select a hyperlink corresponding to the input and hyperlinks included within an area around the input as the hyperlink from which the URL will be extracted. When a user identifies the connected web page by selecting one of a plurality of hyperlinks listed in the web page, a situation in which the user selects the remaining hyperlinks to sequentially identify web pages connected to the respective hyperlinks may be generally predicted. Being influenced by the predicted situation during an ex post facto determination is referred to as Availability Heuristic. Based on the Availability Heuristic, the controller 130 may select the hyperlink corresponding to the user input and the hyperlinks included within the surrounding area which the user is predicted to sequentially identify as the hyperlink from which the URL will be extracted. For example, when the preview screen display event has occurred by an input of the second hyperlink 12 among the at least one hyperlink 11, 12, 13, and 14 illustrated in FIG. 3, the controller 130 may select hyperlinks within a range from the second hyperlink 12 to the next two lines as the hyperlink from which the URL will be extracted. In the embodiment of FIG. 3, the controller 130 may extract the URLs for the third and fourth hyperlinks 13 and 14.

Thereafter, the controller 130 transmits a request message including the URL to the server in operation 234.

The controller 130 may generate a request message for requesting data of the web page corresponding to the collected at least one URL. The request message may be generated in a form corresponding to an arbitrary web communication protocol (e.g., http, ftp, mailto, file, gopher, telnet, news, and the like). For example, when the URL of the hyperlink conforms to the HyperText Transfer Protocol (HTTP), the controller 130 may generate a request message defined in the HTTP specification as the request message. The request message may include information, such as the extracted URL of the hyperlink, a URL protocol version, and the like. When the controller 130 has extracted the URLs for a plurality of hyperlinks, the request message may also be generated to include a plurality of URLs.

The controller 130 controls the communication unit 110 to transmit the generated request message to the server. Through the request message, the controller 130 may request the server to transmit data on the web page corresponding to the URL thereto.

For example, when the preview screen display event has occurred by an input for the second hyperlink 12 in the embodiment of FIG. 3, the controller 130 may transmit a request message including the URL of the second hyperlink 12 to the server.

Thereafter, the controller 130 receives a response message including information on the web page from the server in operation 235.

The controller 130 receives the response message for the request message from the server through the communication unit 110. The response message corresponds to information on the web page corresponding to the URL included in the request message and may include code information, such as HTML (or XHTML), CSS, JavaScript, and the like. When the server cannot search for data on the web page corresponding to the URL, the response message may also include an error message on impossibility of searching for the data.

When the request message includes the plurality of URLs, the response message may also include information on a plurality of web pages.

The controller 130 may temporarily or permanently store the data on the web page included in the received response message in the storage unit 140. The data on the web page stored in the storage unit 140 may be used for identifying, by a user, the corresponding web page from the preview screen and displaying the corresponding web page on the browser without additional loading.

Thereafter, the controller 130 extracts a preview object in operation 236.

The controller 130 may extract a focus area to be shown on the preview screen and the preview object from the received data on the web page.

In an embodiment of the present disclosure, the controller 130 may extract data corresponding to some areas or frames of the web page as the preview object. For example, the controller 130 may extract data corresponding to an upper end area of the web page as the preview object. Alternatively, the controller 130 may extract data corresponding to a body area or a main frame area of the web page as the preview object. At this time, a size of the extracted area may be determined to correspond to a size of the preview screen. The size of the preview screen may be set based on a size and a resolution of the display unit 150, a size of a sub-frame to display the preview screen, and the like.

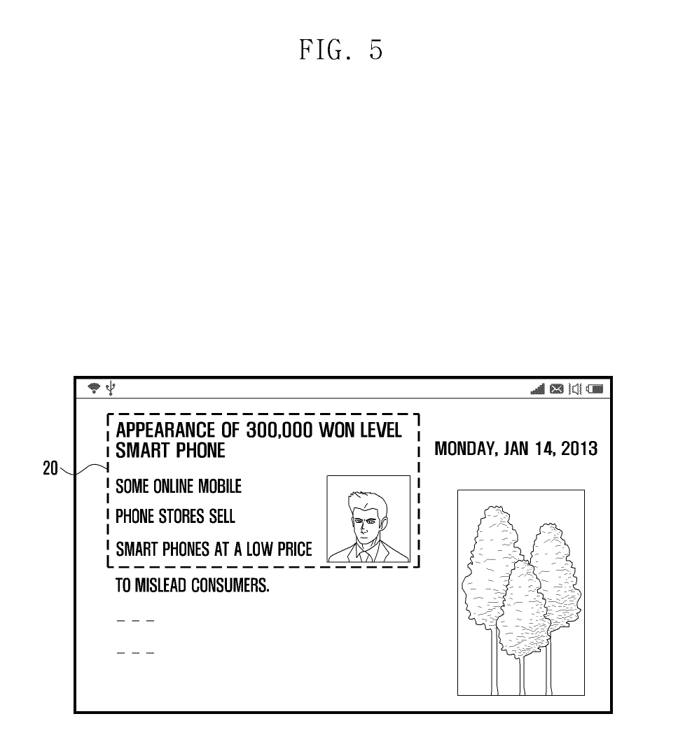

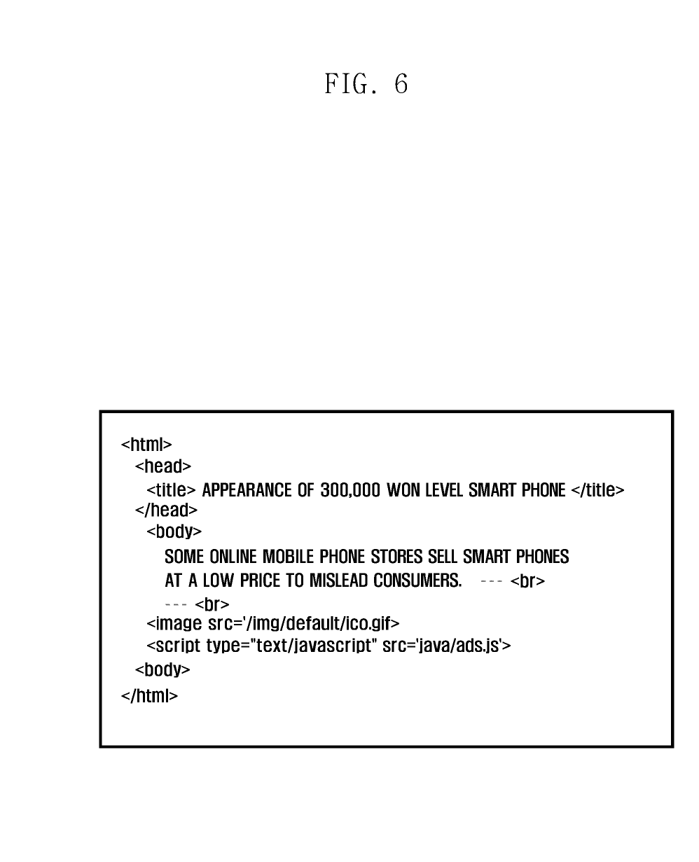

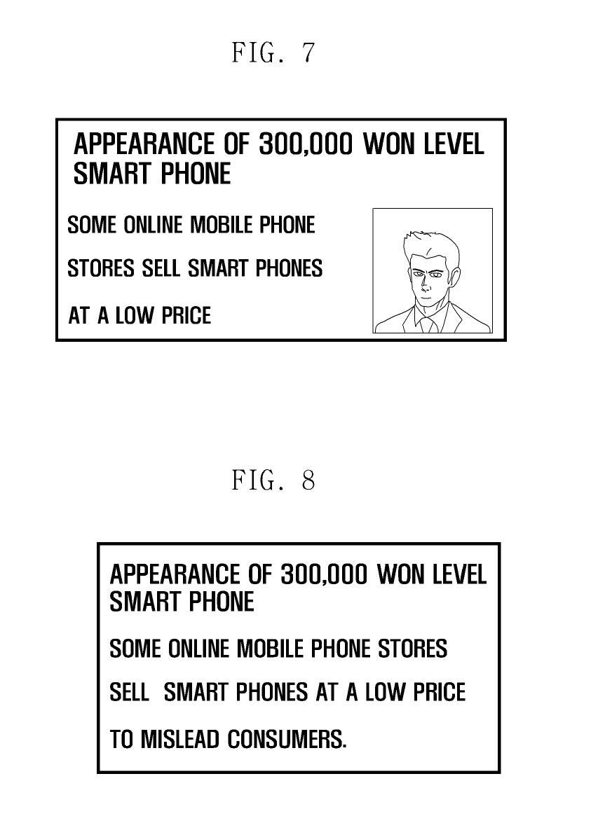

FIG. 5 is a diagram illustrating a procedure of extracting a preview object according to an embodiment of the present disclosure, FIG. 6 is a diagram illustrating an HTML code of a web page according to an embodiment of the present disclosure, FIG. 7 illustrates a preview screen in a case of extracting a partial area of a web page as a preview object according to an embodiment of the present disclosure, and FIG. 8 illustrates a preview screen in a case of extracting texts as a preview object according to an embodiment of the present disclosure.

When the web page includes an arbitrary bulletin (e.g., news, a blog post, a mail, and the like), the controller 130 may also extract, as the preview object, data corresponding to a title and a top area of a body of the corresponding bulletin.

Referring to FIG. 5, for example, when the web page connected by the second hyperlink 12 includes news, the controller 130 may extract data corresponding to a title and a partial area 20 of a top body of the news as a preview area.

In another embodiment of the present disclosure, the controller 130 may extract a text from the data on the received web page as the preview object. When the preview screen includes a still image or a moving image, a lot of resources and time for loading of the still or moving image may be consumed to display the preview screen. Accordingly, the controller 130 may extract the text consuming relatively less resources and time for loading thereof as the preview object. When the received data on the web page includes an HTML code of the web page, the controller 130 may extract texts except for a title and/or tags of a body of the HTML code as the preview object. Alternatively, the controller 130 may also extract texts among an HTML code in a central frame area as the preview object.

Referring to FIG. 5, the controller 130 may extract, as the preview object, texts, namely, “Appearance of 300,000 won level smart phone” and “Some online mobile phone . . . ” except for a title and an image or JavaScript in a body among an HTML code of the web page connected by the second hyperlink 12.

Although various embodiments of the preview object have been described above, the controller 130 may extract various preview objects according to an embodiment of the present disclosure, without being limited thereto.

The controller 130 may temporarily or permanently store information on the extracted preview object in the storage unit 140.

Thereafter, the controller 130 generates a preview screen in operation 237.

The controller 130 generates the preview screen based on the extracted preview object. When a plurality of preview objects has been extracted for a plurality of web pages, the controller 130 may generate a plurality of preview screens for the plurality of preview objects, respectively.

When having extracted data corresponding to some areas or frames of the web page as the preview object, the controller 130 may generate a preview screen configured with the some of the extracted areas or frames.

Referring to FIGS. 5 and 7, for example, the data corresponding to the title and the partial area 20 of the top body of the news among the whole web page connected by the second hyperlink 12 has been extracted as the preview object, the controller 130 may generate a preview screen of the second hyperlink 12 configured with the title and the partial area 20 of the top body of the news, by using the extracted data as illustrated in FIG. 7.

When the controller 130 has extracted the texts from the data on the received web page as the preview object, the controller 130 may generate a preview screen configured with the extracted texts.

Referring to FIGS. 6 and 8, for example, when the title and the texts of the body area has been extracted from the HTML code of the web page connected by the second hyperlink 12 as the preview object, the controller 130 may generate a preview screen of the second hyperlink 12 configured with the extracted texts as illustrated in FIG. 8.

The preview screen may be generated according to a set size. A size of the preview screen may be set according to the set size based on a size and a resolution of the display unit 150, a size of a sub-frame to display the preview screen, and the like.

When the preview screen is completely generated according to the aforementioned process, the controller 130 displays the preview screen in operation 240.

The controller 130 controls the display unit 150 to display the generated preview screen in an area of the browser. The controller 130 may control the display unit 150 to display the preview screen in an area on the browser according to an effect, such as a popup, a split screen, a slide movement, a curtain window, a sub-frame, and the like. When preview screen display requests for a plurality of hyperlinks are generated so that a plurality of preview screens are generated, the controller 130 may display the plurality of preview screens on the browser according to a specific arrangement and location.

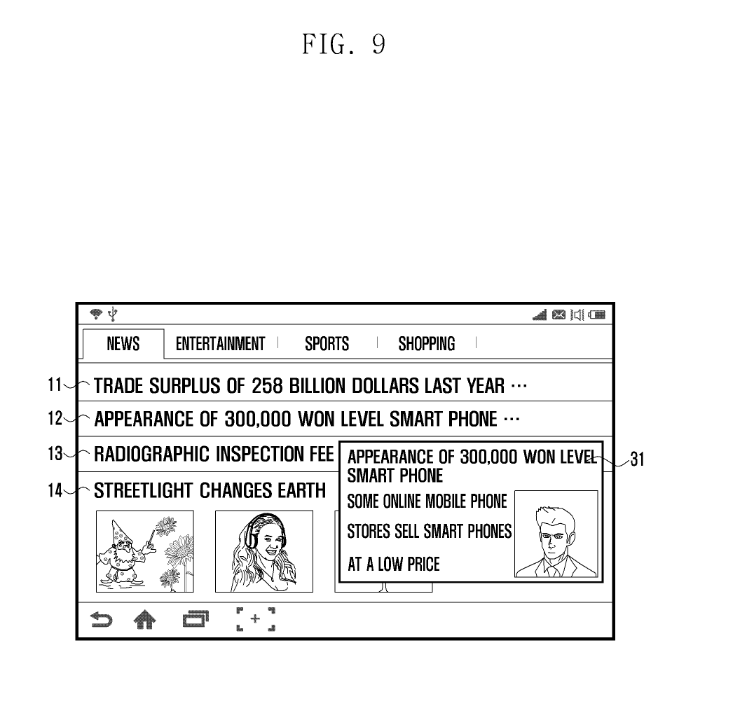

FIG. 9 is a diagram illustrating a display of a preview screen according to a popup effect according to an embodiment of the present disclosure.

Referring to FIG. 9, for example, when the preview screen display request for the second hyperlink 12 is generated in the embodiment of FIG. 3, the controller 130 may display a generated preview screen 31 of the second hyperlink 12 in a peripheral area of the second hyperlink 12 according to a popup effect as illustrated in FIG. 9.

When preview screen display requests are generated for a plurality of hyperlinks including the second hyperlink 12 or a plurality of preview screens are generated for hyperlinks around the second hyperlink 12 based on the Availability Heuristic, the controller 130 may display the plurality of generated preview screens in a peripheral area of the respective hyperlinks according to a popup effect.

The controller 130 may control the display unit 150 to configure a sub-frame for displaying the preview screen in an area of the browser and display the generated preview screen on the sub-frame.

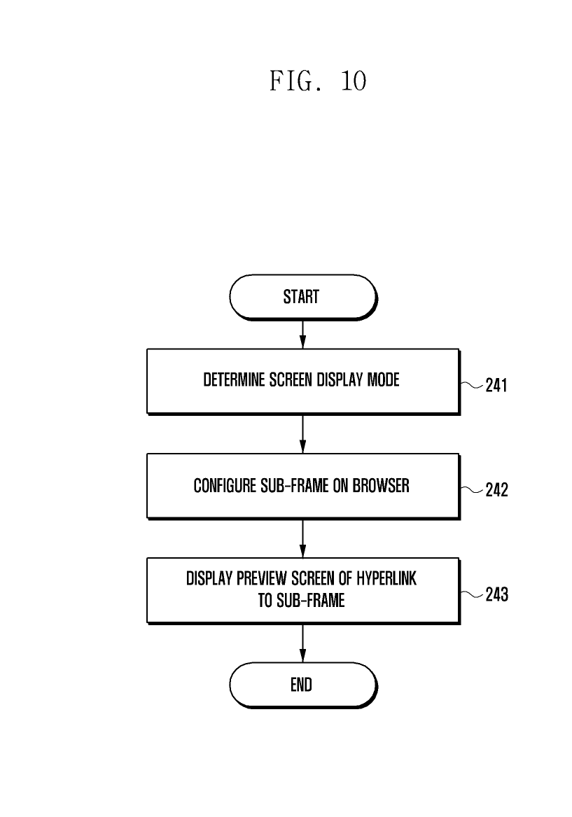

FIG. 10 is a flowchart illustrating a preview screen display method according to an embodiment of the present disclosure.

Referring to FIG. 10, the controller 130 determines a screen display mode of the display unit 150 in operation 241.

The controller 130 determines whether the screen display mode of the display unit 150 corresponds to a portrait mode or a landscape mode. The screen display mode may be determined according to a user setting or a rotation state of the preview screen display device 100 detected by a gyro sensor.

Thereafter, the controller 130 configures the sub-frame on the browser in operation 242.

The controller 130 may configure the sub-frame for the preview screen in an area of the browser according to the determined screen display mode. The sub-frame may be configured in a margin area of the browser, and may have an arbitrary shape, an arbitrary arrangement, and an arbitrary size according to a size and a resolution of the display unit 150, the number of preview screens, and the like.

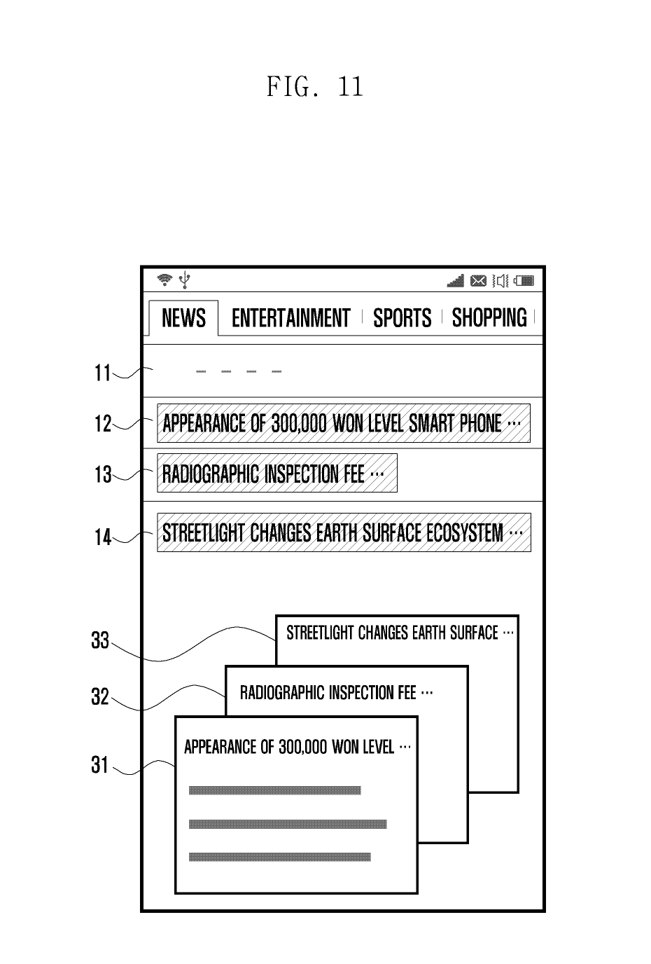

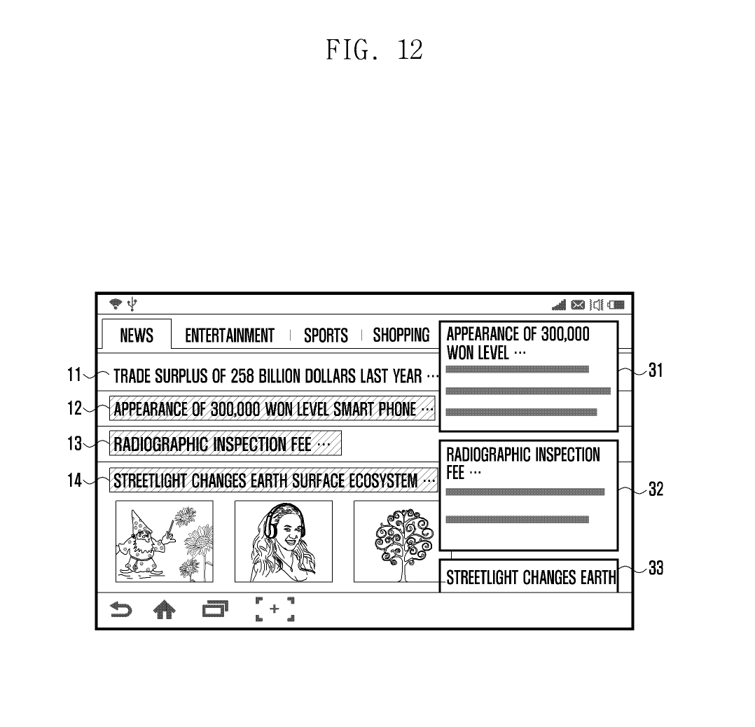

For example, when preview screen display requests for a plurality of hyperlinks are detected or a plurality of hyperlinks are selected based on the Availability Heuristic in the embodiment of FIG. 3, the controller 130 may generate a plurality of preview screens. When it is determined that the screen display mode corresponds to the portrait mode, the controller 130 may configure a plurality of sub-frames 31, 32, and 33 in a lower area of the browser as illustrated in FIG. 11. At this time, the controller 130 may configure the plurality of sub-frames 31, 32, and 33 based on the size of the display unit 150 such that the sub-frames 31, 32, and 33 overlap each other. As the controller 130 configures the sub-frames in the lower area of the browser, the controller 130 may reduce and adjust a size of a main frame to display the web page. Alternatively, when it is determined that the screen display mode corresponds to the landscape mode, the controller 130 may configure a plurality of sub-frames 31, 32, and 33 in a right (or left) blank area of the browser as illustrated in FIG. 12. At this time, the controller 130 may sequentially arrange the plurality of sub-frames 31, 32, and 33 from top to bottom.

Thereafter, the controller 130 displays the preview screen of the hyperlinks on the respective sub-frames in operation 243.

FIG. 11 is a diagram illustrating a procedure of configuring a sub-frame for a preview screen in a portrait mode according to an embodiment of the present disclosure, and FIG. 12 is a diagram illustrating a procedure of configuring a sub-frame for a preview screen in a landscape mode according to an embodiment of the present disclosure.

Referring to FIGS. 11 and 12, the controller 130 controls the display unit 150 to display the generated preview screen of the hyperlinks on the plurality of sub-frames 31, 32, and 33 configured on the browser, respectively. The controller 130 may arrange the preview screens on the sub-frames configured according to an order in which the hyperlinks are displayed in the web page, an order of distance by which the hyperlinks are separated from the hyperlink where the preview screen request is detected, and the like.

The controller 130 may display the hyperlink corresponding to the preview screen with an arrow, a highlight, and another indicator.

As described above, the preview screen display device 100 may configure the preview screen for at least one hyperlink with various objects including texts or an area of a web site according to the user input. Further, the preview screen display device 100 may simultaneously display the plurality of preview screens on the sub-frames configured according to the popup effect or the screen display mode.

In addition, in an embodiment of the present disclosure, the controller 130 may determine in operation 250 whether an input for the preview screen is detected.

The controller 130 determines whether a user input is detected on the browser through the input unit 120 or the display unit 150 implemented with a touch screen. When the user input for the browser is detected while the browser is being displayed, the input unit 120 or the display unit 150 implemented with the touch screen may generate a control signal corresponding to the user input to transfer the generated control signal to the controller 130. The control signal may include a location where the user input has been detected, information on the input unit having generated the user input (e.g., a finger, a stylus pen, and the like), and information on the input type (e.g., information on a touch input, a proximity input, a hovering input, a manipulation state of a button included in a stylus pen, and the like). The controller 130 may obtain information on the detected user input based on the control signal transferred from the input unit 120 or the display unit 150.

The controller 130 determines based on the obtained information from the user input whether the input for the preview screen has been detected. The controller 130 determines whether a location where the user input has been generated corresponds to a location where the preview screen has been displayed. When the user input is generated at the location where the preview screen has been displayed, the controller 130 may determine that the input for the preview screen has been detected.

The input for the preview screen may be configured with, for example, a double click on the preview screen, a drag-and-drop input for the preview screen, and the like.

When the input for the preview screen is detected, the controller 130 may display a web page corresponding to the preview screen on the browser in operation 260.

The controller 130 controls the display unit 150 to display the web page corresponding to the preview screen on the browser. The web page corresponding to the preview screen may be displayed based on the data which has been received in advance in the process of receiving the data on the web page from the server and stored in the storage unit 140. Namely, the controller 130 may display the web page corresponding to the preview screen by using the data on the web page that has been previously received for generation of the preview screen, without additional reception or loading of the data.

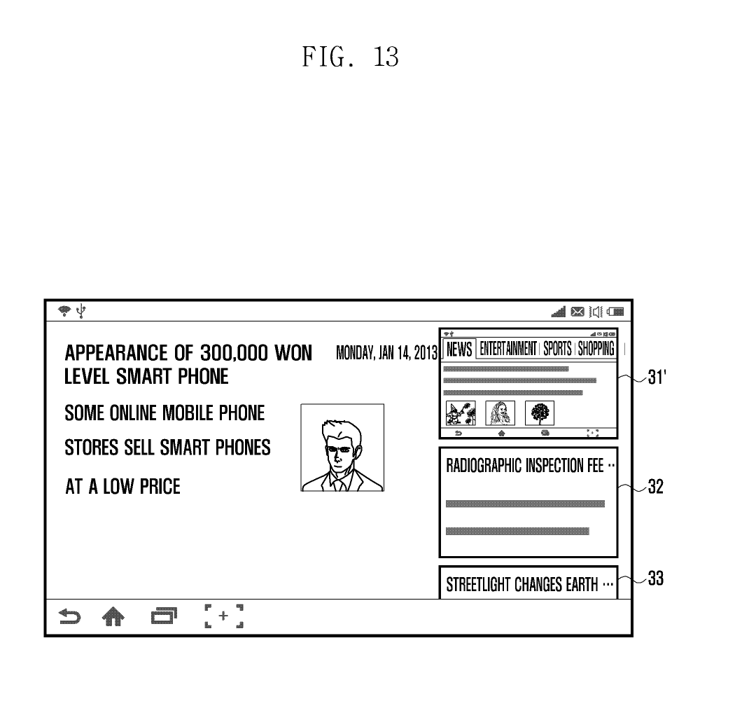

FIG. 13 is a diagram illustrating a procedure of changing a displayed web page with a preview screen according to an embodiment of the present disclosure.

Referring to FIGS. 12 and 13, the controller 130 may display the web page corresponding to the preview screen on a central frame of the browser, namely, a frame on which another web page has been displayed. When an input for the preview screen displayed on any one of the plurality of sub-frames 31, 32, and 33 is generated as illustrated in FIG. 12, the controller 130 may display a preview screen 31′ of another web page previously displayed on the sub-frame 31 on which the preview screen has been displayed, as illustrated in FIG. 13. At the same time, the controller 130 may display the web page corresponding to the preview screen for which the input has been generated on a location where another web page has been displayed. Consequently, the controller 130 may change the previously displayed web page with the web page corresponding to the preview screen for which the input has been detected, thereby enabling a user to simultaneously identify the screens in operation within the single browser.

At this time, the controller 130 may control the display unit 150 to display an area corresponding to the preview screen in a highlight mode. When the controller 130 generates and displays a preview screen configured with an area of the whole web page, the controller 130 may apply a highlight to the area of the web page configuring the preview screen to display the area. The highlight may be configured with a border, shade, an emphasis symbol, and the like, for a partial area.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for displaying a preview screen of a hyperlink in an electronic device, the method comprising:
displaying a web page on a browser;
generating at least one preview screen for each of at least one hyperlink corresponding to a preview screen display request when the preview screen display request for the at least one hyperlink configuring the web page is detected; and
displaying the at least one preview screen in an area of the browser.

2. The method of claim 1, wherein the generating of the at least one preview screen comprises:
transmitting, to a server, a request message for requesting data of at least one web page corresponding to each of the at least one hyperlink corresponding to the request;
receiving a response message comprising the data from the server; and
generating the at least one preview screen by using the data.

3. The method of claim 2, wherein the generating of the at least one preview screen comprises:
extracting data corresponding to a specific area of the at least one web page from the data; and
generating the at least one preview screen configured with the specific area of the at least one web page by using the extracted data.

4. The method of claim 2, wherein the generating of the at least one preview screen comprises:
extracting a text from the data; and
generating the at least one preview screen configured with the text.

5. The method of claim 2, wherein the transmitting of the request message comprises:
comparing legibility of the web page with a threshold value; and
transmitting the request message to the server when the legibility is greater than or equal to the threshold value.

6. The method of claim 2, wherein the transmitting of the request message comprises:
extracting a Uniform Resource Locator (URL) of the at least one hyperlink corresponding to the request and a URL of at least one other hyperlink associated with the at least one hyperlink; and
transmitting the request message comprising the extracted URL to the server.

7. The method of claim 1, wherein the displaying of the at least one preview screen comprises:
displaying the at least one preview screen in the area of the browser according to at least one of a popup effect, a screen split effect, a slide movement effect, a curtain window effect, and a sub-frame effect.

8. The method of claim 1, wherein the displaying of the at least one preview screen comprises:
configuring at least one sub-frame for the at least one preview screen in the area on the browser; and
displaying the at least one preview screen on the at least one sub-frame.

9. The method of claim 8, wherein the configuring of the at least one sub-frame comprises:
determining whether a screen display mode is a landscape mode or a portrait mode; and
configuring the at least one sub-frame in a blank area of the browser according to the screen display mode.

10. The method of claim 1, further comprising:
displaying, when an input for the at least one preview screen is received, a web page corresponding to the at least one preview screen corresponding to the input on the browser.

11. A device for displaying a preview screen of a hyperlink, the device comprising:
a display unit configured to display a web page on a browser;
an input unit configured to detect a preview screen display request for at least one hyperlink configuring the web page; and
a controller configured to generate at least one preview screen for each of at least one hyperlink corresponding to the request and to control the display unit to display the at least one preview screen in an area of the browser, when the request is detected through the input unit.

12. The device of claim 11, further comprising:
a communication unit configured to perform data communication with a server,
wherein the controller is further configured to control the communication unit to transmit, to the server, a request message for requesting data of at least one web page corresponding to each of the at least one hyperlink corresponding to the request and to receive a response message comprising the data from the server, and to generate the at least one preview screen by using the data.

13. The device of claim 12, wherein the controller is further configured to extract data corresponding to a specific area of the at least one web page from the data and to generate the at least one preview screen configured with the specific area of the at least one web page by using the extracted data.

14. The device of claim 12, wherein the controller is further configured to extract a text from the data and to generate the at least one preview screen configured with the text.

15. The device of claim 12, wherein the controller is further configured to compare legibility of the web page with a threshold value, and to control the communication unit to transmit the request message to the server when the legibility is greater than or equal to the threshold value.

16. The device of claim 12, wherein the controller is further configured to extract a Uniform Resource Locator (URL) of the at least one hyperlink corresponding to the request and a URL of at least one other hyperlink associated with the at least one hyperlink, and to control the communication unit to transmit the request message comprising the extracted URL to the server.

17. The device of claim 11, wherein the display unit is further configured to display the at least one preview screen in the area of the browser according to at least one of a popup effect, a screen split effect, a slide movement effect, a curtain window effect, and a sub-frame effect under control of the controller.

18. The device of claim 11, wherein the controller is further configured to configure at least one sub-frame for the at least one preview screen in the area on the browser, and to control the display unit to display the at least one preview screen on the at least one sub-frame.

19. The device of claim 18, wherein the controller is further configured to determine whether a screen display mode is a landscape mode or a portrait mode, and to configure the at least one sub-frame in a blank area of the browser according to the screen display mode.

20. The device of claim 11, wherein the controller is further configured to control the display unit to display, when an input for the at least one preview screen is received, a web page corresponding to the input for the at least one preview screen corresponding to the input on the browser.

21. A non-transitory computer-readable storage medium configured to store a computer program of instructions configured to be readable by at least one processor for instructing the at least one processor to execute a computer process for performing the method of claim 1.
